(19) United States
(12) Patent Application Publication
(10) Pub. No.: US 2014/0290132 A1
(43) Pub. Date: Oct. 2, 2014

(54) Landscape Edging System

(71) Applicant: Michael R.A. Bent, Peyton, CO (US)

(72) Inventor: Michael R.A. Bent, Peyton, CO (US)

(73) Assignee: Michael R.A. Bent, Peyton, CO (US)

(21) Appl. No.: 14/229,479

(22) Filed: Mar. 28, 2014

Related U.S. Application Data
(60) Provisional application No. 61/806,759, filed on Mar. 29, 2013.

(51) Int. Cl. A01G 1/08

(52) U.S. Cl. CPC A01G 1/08
USPC 47/33

(57) ABSTRACT

A landscape edging system uses a series of holes placed at even intervals vertically and horizontally creating two rows of holes along straight pieces of edging, one row along the top and another along the bottom of the edging. The purpose of these holes is to allow runs of edging to be fastened together which then function as one longer piece. The manufacturing of the edging also includes corner/end pieces, shorter pieces of edging for bracing, and edging stakes. The edging pieces are fastened using any standard type of rivets. The edging system of the present invention can be bent easily into virtually any design or simply used for straight borders.

### CROSS-REFERENCE TO RELATED APPLICATIONS

### Related Application

The present invention claims the benefit of priority to U.S. Provisional Patent Application Ser. No. 61/806,759 filed Mar. 29, 2013 which is hereby incorporated by reference in its entirety for all purposes as if fully set forth herein.

### BACKGROUND OF THE INVENTION

This invention relates to landscaping and more particularly to an edging system and method of implementing the edging system.

Landscape edging systems are well-known in the art. However, existing edging systems can be expensive and difficult to implement. What is desired is an edging system that has sufficient strength and rigidity, but which is also flexible enough to be bendable to achieve desired shapes and configurations while being cost-effective and easy to implement.

### SUMMARY OF THE INVENTION

According to the present invention, an improved design of landscape edging is disclosed. The method of the present invention uses a series of holes placed at even intervals 3″ vertically and 2″ horizontally creating two rows of holes along straight pieces of edging, one row along the top and another along the bottom of the edging. The purpose of these holes is to allow runs of edging to be fastened together allowing them to function as one longer piece. The manufacturing of this edging also includes corner/end pieces, shorter pieces of edging for bracing, and edging stakes. The edging pieces are fastened together using any standard type of rivets that range in size and material to allow landscapers the freedom of choosing their preferred type of rivet. These rivets can range in size from 3/32″ to 5/32″ diameter with length dependent upon how many pieces of edging are being fastened together. These rivets can be made of aluminum, steel, galvanized steel or similar materials. The edging system of the present invention can be bent easily into virtually any design or simply used for straight borders.

### BRIEF DESCRIPTION OF THE DRAWINGS

FIG. 1 is a side view of edging strips used in the edging system according to the present invention;

FIG. 2 is perspective view of bracing strips and corner/elbow pieces used in the edging system according to the present invention;

FIG. 3 is a side view of a corner/elbow piece fastened to an elbow piece and a bracing piece orthogonal to the plane of the drawing, particularly showing a pop-rivet before and after a mandrel is pulled;

FIG. 4 is a perspective view of intersecting edging strips held tightly together with rivets leaving no gaps or spaces;

FIG. 5 is a plan view of a patio and walking paths suitable for use with the edging system of the present invention;

FIG. 6 is a perspective view of the landscape edging system according to the present invention using six corner/elbow pieces, two bracing pieces, and four edging strips; and

FIG. 7 is front and side view of an edging stake used in the landscape edging system according to the present invention.

### DETAILED DESCRIPTION

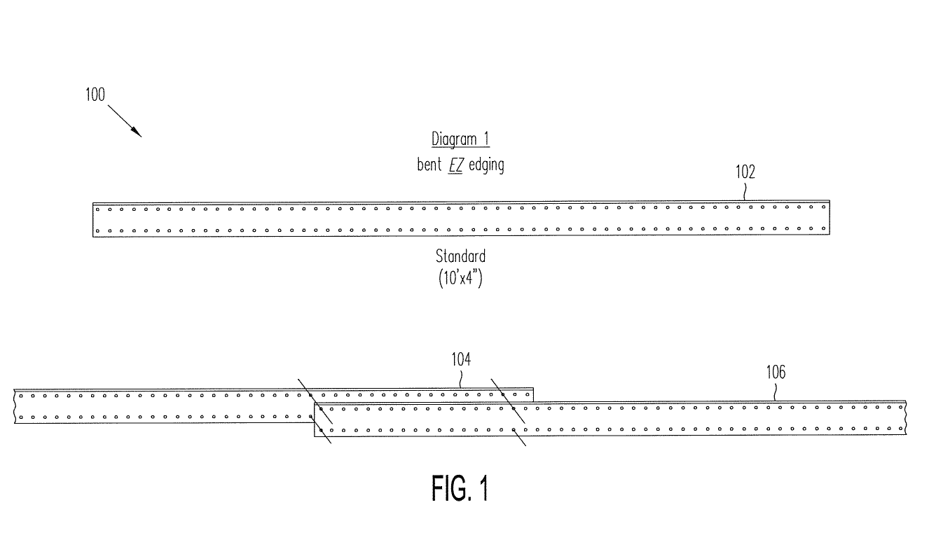

The edging design of the landscape edging system of the present invention is described generally with reference to FIG. 1.

The landscape edging system 100 of the present invention comprises two types of edging including a regular straight edge and a roll top edge and comes in a standard ten foot lengths and four inch widths as well as special order lengths (any lengths totaling more than or less than ten feet). Both the standard and special order lengths include two rows of holes placed at even intervals across the length of edging. These holes are used to fasten multiple pieces of edging in order to allow them to function as one longer piece. A standard edging piece 102 is shown in FIG. 1. Two standard edging pieces 104 and 106 are also shown in FIG. 1 in an overlapped configuration prior to being joined together, as will be described in further detail below. These pieces, once joined together, can then be used to form long curving designs in landscape as well as long curving walking paths. The pieces could also be fastened together to form shapes around trees and to form islands for planting. Formed shapes include circles, ovals and other arbitrary shapes.

The edging strips shown in FIG. 1 are ideally made of galvanized steel, but aluminum and alloy materials can also be used. The holes are made to accommodate the diameter of the pop-rivets, described in further detail below, typically between 3/32″ to 5/32″. The thickness of the galvanized steel can also vary as required. A minimum thickness is required for strength, but should the thickness should not be so great to impact the desired flexibility of the material.

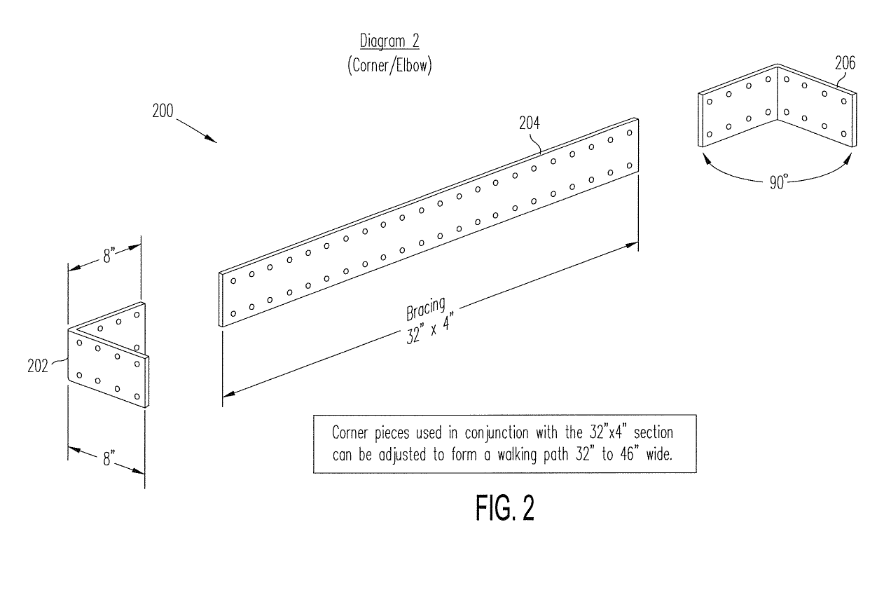

The corner/elbow and bracing pieces 200 according to the present invention are described generally with reference to FIG. 2.

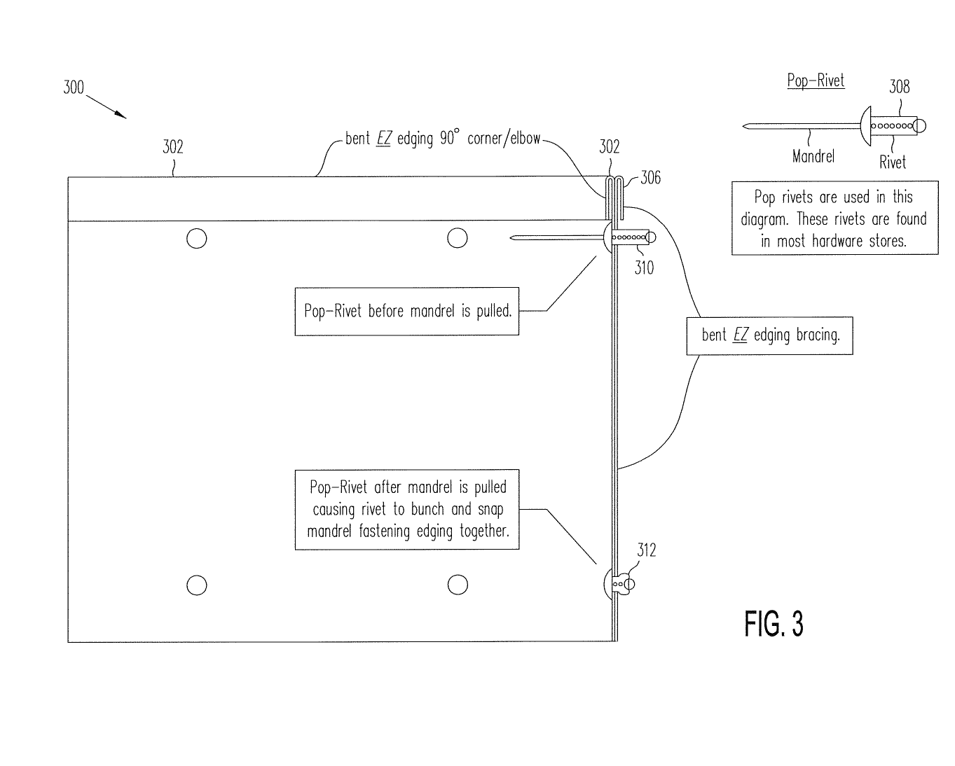

The corner/elbow piece elbows are sixteen inches of edging bent at ninety degree angles. These pieces are manufactured mainly for supporting two rows of upright edging running parallel to each other, when used with bracing and fastened with rivets. FIG. 2 shows two corner/elbow pieces 202 and 206, and a single bracing piece 204. FIG. 3 shows a side view of an attached section 300 of the landscape edging system of the present invention. More particularly, FIG. 3 shows a side view of a corner/elbow piece 302 fastened to a bracing piece 306 orthogonal to the plane of the drawing, particularly showing a pop-rivet before (310) and after (312) a mandrel is pulled.

The corner angles can be adjusted to angles greater than or less than ninety degrees when used in other applications of landscape designs to include, but are not limited to the following:

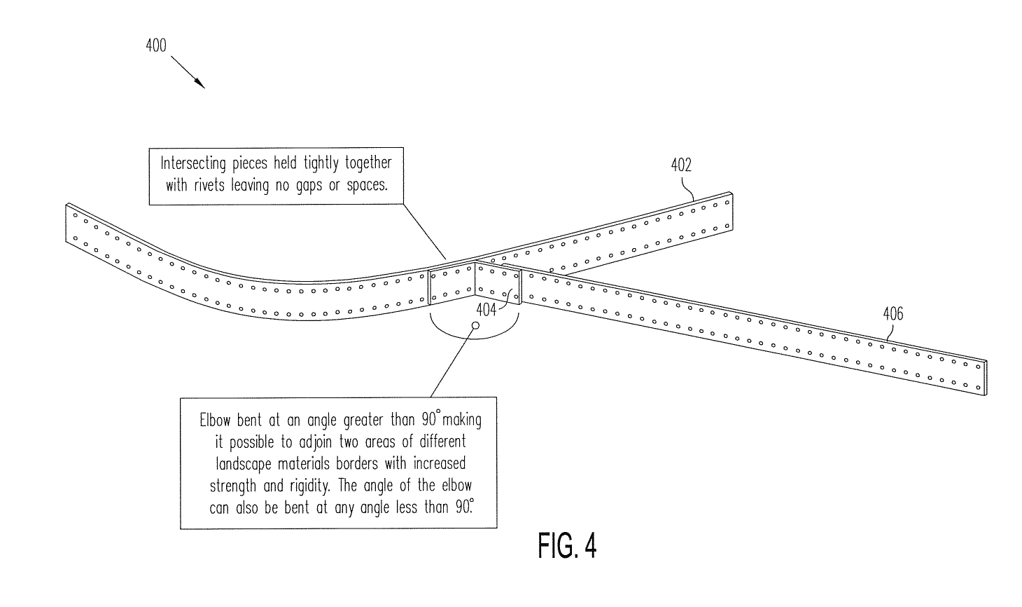

1) Fastening to different sections of landscape into one thus preventing separation or gaps between sections and increasing edging strength. A portion 400 of the landscape edging system, according to the present invention, is shown in FIG. 4 and includes two edging pieces 402 and 406 joined with a corner/elbow piece 404.

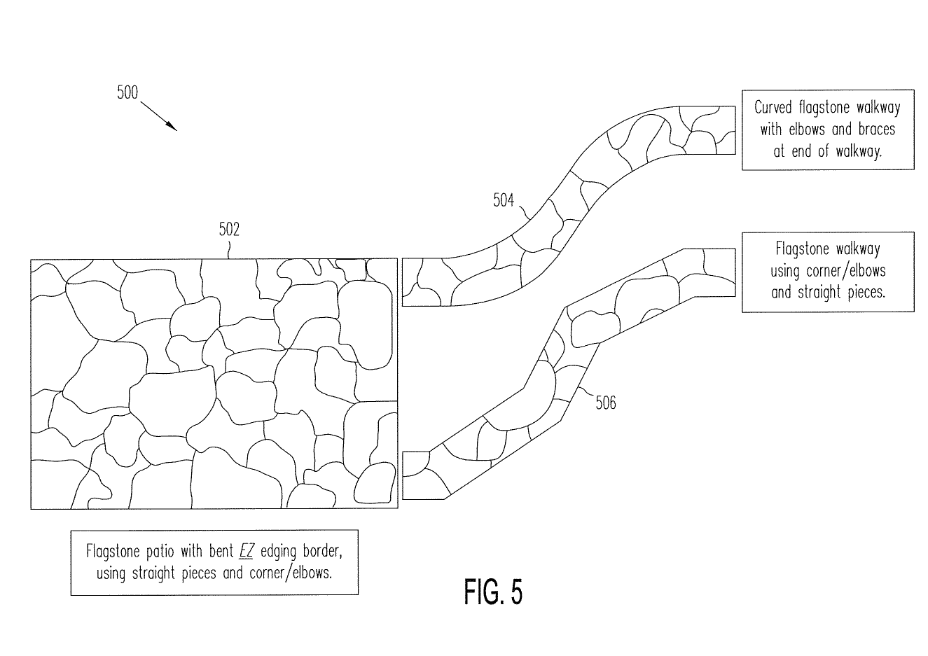

2) Creating walking paths consisting of sharp corners instead of curved paths. This is shown in the landscaped area 500 of FIG. 5 including a patio 502, curved walkway 504, and jagged walkway 506. The landscape edging system of the present invention is suitable for use with any portion of the landscaped area.

3) Geometric shapes such as (but not limited to) triangles, squares, octagons, and any other shapes using angles used around trees or for planting beds (not shown).

4) Corner angles can also be used with straight pieces to form borders for patios or other platforms (again, as shown in FIG. 5).

5) The corner pieces can also be used in conjunction with the bracing pieces at the end of walking paths (see also FIG. 4).

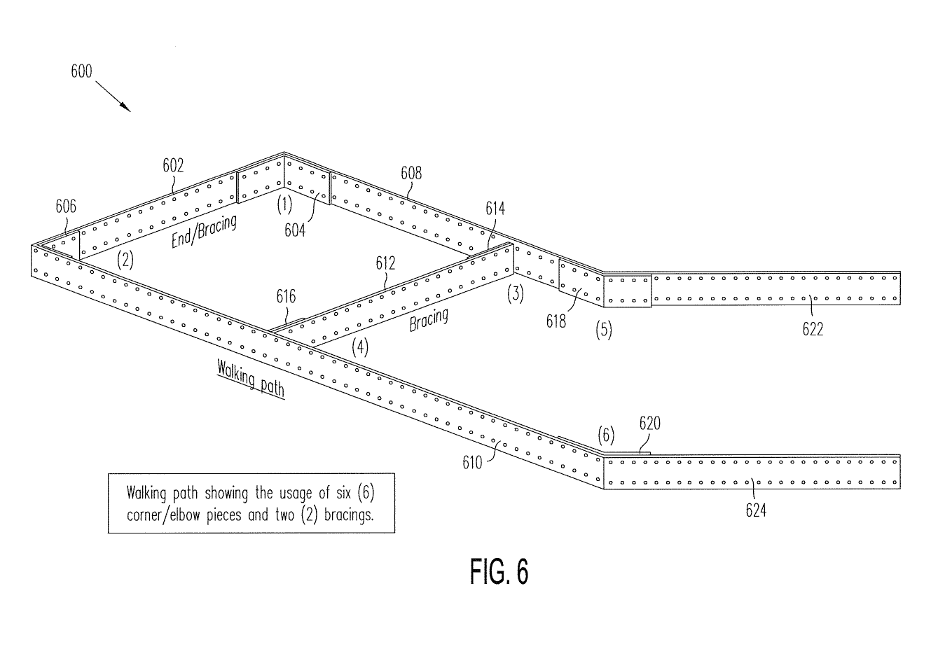

The bracing system 600 used in the landscape edging system of the present invention is described generally with respect to FIG. 6.

The bracing pieces are pieces of edging manufactured at thirty-two inch lengths (Standard) or special order lengths measuring more or less than the standard length. These are manufactured mainly for supporting parallel rows of upright edging as mentioned in corner/end piece paragraph. They can be used as extension edging or at the end of walking paths when used with corners. The bracing pieces are fastened in the same manner as all of the landscape edging pieces previously described using rivets. In FIG. 6, two corner/elbow pieces 604 and 606 are shown attached to a bracing piece 602. Corner/elbow piece 606 is in turn attached to edging piece 610, and corner elbow piece 604 is in turn attached to edging piece 608. Corner/elbow pieces 614 and 616 are respectively attached to edging pieces 608 and 610. Bracing piece 612 is attached to corner/elbow pieces 614 and 616. Edging pieces 622 and 624 are respectively attached to edging pieces 608 and 610 using corner/elbow pieces 618 and 620. Note that corner/elbow pieces have an angle of more than ninety degrees. The bracing system may be used in any application requiring extra strength and/or rigidity.

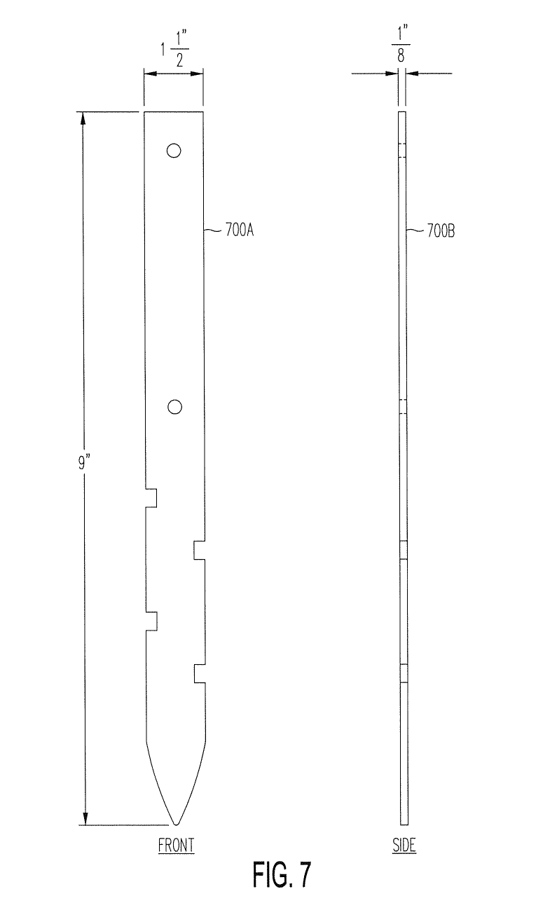

The optional staking system according to the present invention is generally described with respect to FIG. 7.

The staking system of the present invention includes 9″×1½″×⅛″ stakes with two holes which align with the top and bottom holes in the landscaping pieces previously described. The primary function of these stakes is to strengthen the edging in an upright position when lateral forces are placed on the edging when used to form walking paths or when used as borders for other heavy landscape materials. There are also notches in the lower end of the stakes which are designed to lock into the soil with the purpose of minimizing edging up/down movement in climates where soil freezes and thaws. The stakes can be used in single or double fashion depending on strength needed for support. These stakes are also fastened using rivets. A stake is shown in a front view (700A) and a side view (700B) in FIG. 7. The stake, like the other landscaping pieces previously described can be made of galvanized steel, aluminum or other alloy materials. While a width of ⅛″ is shown in FIG. 7, other thicknesses can be used as will be apparent to those skilled in the art.

A general method of operation of using the landscape edging system of the present invention is now described:

1) lay out fiat the number of edging pieces needed for a given landscaping project;

2) overlap the pieces as needed, using a minimum of four inches of overlap on the ground;

3) rivet the overlapped pieces together using a rivet gun or other such device using the top and bottom rows of holes at least in the edge portions of each edging strip;

4) repeat for all pieces until one solid attached vertical piece is achieved; and

5) affix attached vertical piece to the ground using standard edging pins.

The method of operation proceeds in a similar fashion using the bracing and elbow pieces, wherein the pieces are pre-staged and overlapped before riveting the pieces together and affixing the solid attached piece to the ground. When heavier materials are used such as rocks, the previously described stakes are used instead of the standard edging pins. The stakes are fastened to the vertical solid piece before hammering the stakes into the ground. The stakes are attached to the landscape edging using pieces with rivets as previously described. When encountering rough terrain, a single rivet in the top row of the edging pieces may be used to allow the edging strips to pivot with respect to each other so that the contours of the terrain may be followed.

While numerous references have been made to material selection, widths, lengths, thicknesses, and hole sizes, it will be apparent to those skilled in the art that these can all be changed as required for a specific implementation. Additionally, a method of operation has been described that can also be changed as required to meet the challenges of a specific implementation.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

I claim:

1. A landscape edging system comprising:
a first edging piece comprising two rows of holes; and
a second edging piece comprising two rows of holes corresponding to the two rows of holes in the first edging piece,
wherein the first edging piece is attached to the second edging piece in an overlapping section wherein at least one hole in the first edging piece aligns with at least one hole in the second edging piece.

2. The landscape edging system according to claim 1 wherein the first edging piece is attached to the second edging piece with rivets.

3. The landscape edging system according to claim 1 wherein the first and second edging pieces comprise galvanized steel or aluminum.

4. The landscape edging system according to claim 1 further comprising a corner piece comprising two rows of holes corresponding to the two rows of holes in the first edging piece, wherein the first edging piece is attached to the corner piece in an overlapping section wherein at least one hole in the first edging piece aligns with at least one hole in the corner piece.

5. The landscape edging system according to claim 4 further comprising a bracing piece comprising two rows of holes corresponding to the two rows of holes in the corner piece, wherein the bracing piece is attached to the corner piece in an overlapping section wherein at least one hole in the bracing piece aligns with at least one hole in the corner piece.

6. The landscape edging system according to claim 1 wherein the first edging piece and the second edging piece each comprise a straight top edge.

7. The landscape edging system according to claim 1 wherein the first edging piece and the second edging piece each comprise a roll top edge.

8. The landscape edging system according to claim 1 further comprising a stake for affixing to the first and second edging pieces.

9. The landscape edging system of claim 8 wherein the stake comprises two holes corresponding to a hole in each of the two rows of holes in the first and second edging pieces.

10. The landscape edging system of claim 8 wherein the stake comprises galvanized steel.

11. A landscape edging method comprising:
providing a first edging piece comprising two rows of holes;
providing a second edging piece comprising two rows of holes corresponding to the two rows of holes in the first edging piece; and
attaching the first edging piece to the second edging piece in an overlapping section such that at least one hole in the first edging piece aligns with at least one hole in the second edging piece.

12. The landscape edging system according to claim 11 wherein the first edging piece is attached to the second edging piece with rivets.

13. The landscape edging system according to claim 11 wherein the first and second edging pieces comprise galvanized steel or aluminum.

14. The landscape edging system according to claim 11 further comprising providing a corner piece comprising two rows of holes corresponding to the two rows of holes in the first edging piece, wherein the first edging piece is attached to the corner piece in an overlapping section wherein at least one hole in the first edging piece aligns with at least one hole in the corner piece.

15. The landscape edging system according to claim 14 further comprising providing a bracing piece comprising two rows of holes corresponding to the two rows of holes in the corner piece, wherein the bracing piece is attached to the corner piece in an overlapping section wherein at least one hole in the bracing piece aligns with at least one hole in the corner piece.

16. The landscape edging system according to claim 11 wherein the first edging piece and the second edging piece each comprise a straight top edge.

17. The landscape edging system according to claim 11 wherein the first edging piece and the second edging piece each comprise a roll top edge.

18. The landscape edging system according to claim 11 further comprising providing a stake for affixing to the first and second edging pieces.

19. The landscape edging system of claim 18 wherein the stake comprises two holes corresponding to a hole in each of the two rows of holes in the first and second edging pieces.

20. The landscape edging system of claim 18 wherein the stake comprises galvanized steel.
